(19) United States
(12) Patent Application Publication
(10) Pub. No.: US 2020/0250490 A1
(43) Pub. Date: Aug. 6, 2020

(54) MACHINE LEARNING DEVICE, ROBOT SYSTEM, AND MACHINE LEARNING METHOD

(71) Applicant: SEIKO EPSON CORPORATION, Tokyo (JP)

(72) Inventor: Kinya Ozawa, Shiojiri-Shi (JP)

(21) Appl. No.: 16/777,389

(22) Filed: Jan. 30, 2020

(30) Foreign Application Priority Data
Jan. 31, 2019 (JP) 2019-015321

(51) Int. Cl. G06K 9/62; B25J 11/00; G06N 20/00; B25J 9/16

(52) U.S. Cl. CPC G06K 9/6263; B25J 9/163; G06N 20/00; B25J 11/0005

(57) ABSTRACT

A machine learning device learning a movement of a robot where a human and the robot collaboratively work includes: a state observation unit observing a state variable representing a state of the robot when the human and the robot collaboratively work; a reward calculation unit calculating a reward based on control data for controlling the robot, the state variable, an action of the human, and a facial expression of the human; and a value function update unit updating an action value function for controlling a movement of the robot, based on the reward and the state variable.

The present application is based on, and claims priority from JP Application Serial Number 2019-015321, filed Jan. 31, 2019, the disclosure of which is hereby incorporated by reference herein in its entirety.

### BACKGROUND

### 1. Technical Field

The present disclosure relates to a machine learning device, a robot system, and a machine learning method.

### 2. Related Art

In a robot system according to the related art, in order to secure the safety of a human, a safety measure is taken so that the human cannot enter the work area of a robot during a period when the robot is moving. For example, a safety fence is installed around the robot, prohibiting the human from entering the area inside the safety fence during the period when the robot is moving.

Recently, a robot working collaboratively with a human, or a collaborative robot, has been researched, developed, and put into practical use. With such a robot or robot system, the robot and a human worker collaboratively do one piece of work in the state where a safety fence is not provided around the robot.

Also, a robot system that can further improve a robot movement where a human and a robot work collaboratively is disclosed. JP-A-2018-30185 is an example of this.

However, the robot of JP-A-2018-30185 determines an action of the human via a touch sensor of the robot and therefore may mistakenly determine the action of the human due to a malfunction of the touch sensor or a wrong operation by the human.

### SUMMARY

A machine learning device according to an aspect of the present disclosure is a machine learning device learning a movement of a robot where a human and the robot collaboratively work and including: a state observation unit observing a state variable representing a state of the robot when the human and the robot collaboratively work; a reward calculation unit calculating a reward based on control data for controlling the robot, the state variable, an action of the human, and a facial expression of the human; and a value function update unit updating an action value function for controlling a movement of the robot, based on the reward and the state variable.

In the machine learning device, the state variable may include an output from an image sensor, a camera, a force sensor, a microphone, and a tactile sensor.

In the machine learning device, the reward calculation unit may calculate the reward by adding a second reward based on the action of the human and a third reward based on the facial expression of the human to a first reward based on the control data and the state variable.

In the machine learning device, as the second reward, a positive reward may be set when the robot is stroked via the tactile sensor provided at the robot, and a negative reward may be set when the robot is hit. Alternatively, a positive reward may be set when the robot is praised via a microphone provided at a part of the robot or near the robot or worn by the human, and a negative reward may be set when the robot is reprimanded.

In the machine learning device, as the third reward, the facial expression of the human may be recognized via the image sensor provided at the robot, and a positive reward may be set when the facial expression of the human is a smile or an expression of pleasure, and a negative reward may be set when the facial expression of the human is a frown or a cry.

The machine learning device may further include a decision making unit deciding command data prescribing a movement of the robot, based on an output from the value function update unit.

In the machine learning device, the image sensor may be provided directly at the robot or in a periphery of the robot. The camera may be provided directly at the robot or in an upper periphery of the robot. The force sensor may be provided at a base part or a hand part of the robot or at a peripheral facility. The tactile sensor may be provided at a part of the robot or at a peripheral facility.

A robot system according to another aspect of the present disclosure includes the foregoing machine learning device, the robot working collaboratively with the human, and a robot control unit controlling a movement of the robot. The machine learning device learns the movement of the robot by analyzing distribution of a feature point or a workpiece after the human and the robot collaboratively work.

The robot system may further include: an image sensor, a camera, a force sensor, a tactile sensor, a microphone, and input device; and a work intention recognition unit receiving an output from the image sensor, the camera, the force sensor, the tactile sensor, the microphone, and the input device, and recognizing an intention of work.

The robot system may further include a speech recognition unit recognizing a speech of the human inputted from the microphone. The work intention recognition unit may correct the movement of the robot, based on the speech recognition unit.

The robot system may further include: a question generation unit generating a question to the human, based on an analysis of work intention by the work intention recognition unit; and a speaker delivering the question generated by the question generation unit to the human.

In the robot system, the microphone may receive a response from the human to the question from the speaker. The speech recognition unit may recognize the response from the human inputted via the microphone and output the response to the work intention recognition unit.

In the robot system, the state variable inputted to the state observation unit of the machine learning device may be an output from the work intention recognition unit. The work intention recognition unit may convert a positive reward based on the action of the human into a state variable that is set to the positive reward, and output the state variable to the state observation unit. The work intention recognition unit may convert a negative reward based on the action of the human into a state variable that is set to the negative reward, and output the state variable to the state observation unit. The work intention recognition unit may convert a positive reward based on the facial expression of the human into a state variable that is set to the positive reward, and output the state variable to the state observation unit. The work intention recognition unit may convert a negative reward based on the facial recognition of the human into a state variable that is set to the negative reward, and output the state variable to the state observation unit.

In the robot system, the machine learning device may be able to be set not to learn any more a movement learned up to a predetermined time point.

In the robot system, the robot control unit may stop the robot when the tactile sensor detects a slight collision.

A machine learning method according to still another aspect of the present disclosure is a machine learning method for learning a movement of a robot where a human and the robot collaboratively work and including: observing a state variable representing a state of the robot when the human and the robot collaboratively work; calculating a reward based on control data for controlling the robot, the state variable, an action of the human, and a facial expression of the human; and updating an action value function for controlling a movement of the robot, based on the reward and the state variable.

### BRIEF DESCRIPTION OF THE DRAWINGS

FIG. 1 is a block diagram showing a robot system according to an embodiment.

FIG. 2 schematically shows a neuron model.

FIG. 3 schematically shows a three-layer neural network formed by a combination of the neurons shown in FIG. 2.

FIG. 4 schematically shows an example of the robot system according to the embodiment.

FIG. 5 schematically shows a modification example of the robot system shown in FIG. 4.

FIG. 6 is a block diagram explaining an example of the robot system according to the embodiment.

FIGS. 7A and 7B explain an example of a movement in the robot system shown in FIG. 6.

FIG. 8 explains an example of processing in the case where the movement in the robot system shown in FIGS. 7A and 7B is achieved by deep learning employing a neural network.

### DESCRIPTION OF EXEMPLARY EMBODIMENTS

An embodiment of the present disclosure will now be described with reference to the drawings. In the drawings used here, components to be explained are properly enlarged or reduced so as to be recognizable.

An embodiment of the machine learning device, the robot system, and the machine learning method according to the present disclosure will now be described in detail with reference to the accompanying drawings.

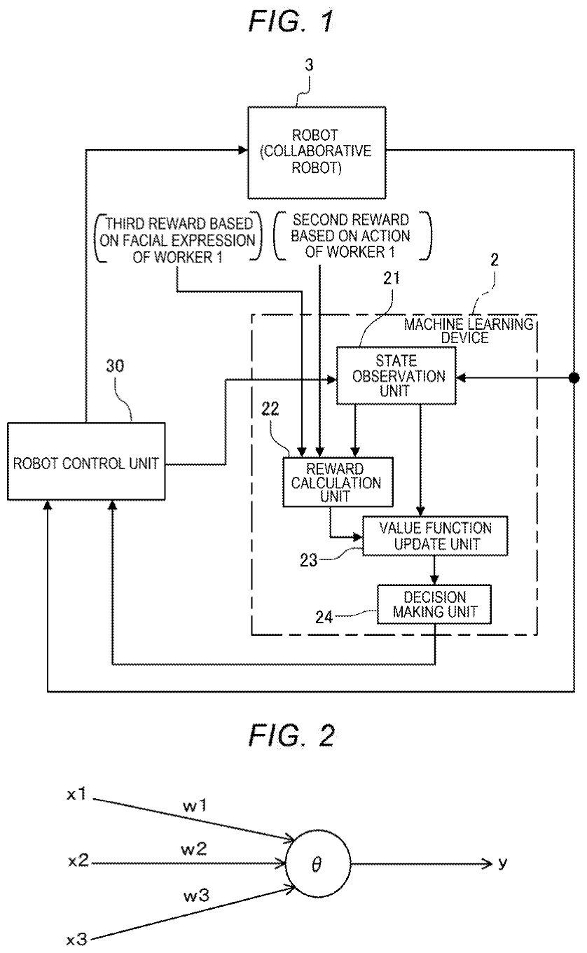

FIG. 1 is a block diagram showing the robot system according to this embodiment.

The robot system in this embodiment is for learning a movement of a robot 3 as a collaborative robot where a human worker 1 and the robot 3 collaboratively work. As shown in FIG. 1, the robot system has the robot 3, a robot control unit 30, and a machine learning device 2. The machine learning device 2 can be integrated with the robot control unit 30 but may be provided from the robot control unit 30.

The machine learning device 2 is configured to learn, for example, a movement command for the robot 3 set by the robot control unit 30, and includes a state observation unit 21, a reward calculation unit 22, a value function update unit 23, and a decision making unit 24, as shown in FIG. 1. The state observation unit 21 observes the state of the robot 3. The reward calculation unit 22 calculates a reward based on an output from the state observation unit 21, an action of the worker 1, and a facial expression of the worker 1.

That is, for example, control data for the robot 3 from the robot control unit 30, a state variable observed by the state observation unit 21 as an output from the state observation unit 21, a second reward based on the action of the worker 1, and a third reward based on the facial expression of the worker 1 are inputted to the reward calculation unit 22. The reward calculation unit 22 thus calculates the reward. Specifically, for example, a positive reward is set when the robot 3 is stroked via a tactile sensor 41 shown in FIG. 4 provided at a part of the robot 3, and a negative reward is set when the robot 3 is hit. The reward calculation unit 22 can calculate the reward by adding the second reward based on the action of the worker 1 to the first reward based on the control data and the state variable.

Also, the facial expression of the worker 1 is recognized via an image sensor 12 shown in FIG. 4 provided in a periphery of the robot 3. A positive reward is set when the facial expression of the worker 1 is a smile or an expression of pleasure, and a negative reward is set when the facial expression of the worker 1 is a frown or a cry. The reward calculation unit 22 can calculate the reward by adding the third reward based on the facial expression of the worker 1 to the first reward based on the control data and the state variable.

Alternatively, a positive reward is set when the robot 3 is praised via a microphone 42 shown in FIG. 4 provided at a part of the robot 3 or near the robot 3 or worn by the worker 1, and a negative reward is set when the robot 3 is reprimanded. The reward calculation unit 22 may calculate the reward by adding the second reward based on the action of the worker 1 and the third reward based on the facial expression of the worker 1 to the first reward based on the control data and the state variable.

When positive and negative rewards differ between the second reward and the third reward, the third reward may be preferentially used to decide the reward. For example, even in a setting where a negative reward is provided as the second reward, when a positive reward is generated as the third reward, the positive reward of the third reward is preferentially used.

Also, learning to decide a positive reward and a negative reward of the third reward may be carried out.

The image sensor 12 picks up a facial image of the worker 1 working collaboratively with the robot 3. The image sensor 12 is, for example, a CCD (charge-coupled device) installed at the robot 3. A CMOS image sensor may be used as the image sensor 12.

The value function update unit 23 updates an action value function associated with a movement command for the robot 3 found from the current state variable, based on the reward calculated by the reward calculation unit 22. Here, the state variable observed by the state observation unit 21 includes, for example, outputs from the image sensor 12, the microphone 42, a camera 44, a force sensor 45, and the tactile sensor 41, as described in detail later. The state variable includes an output from the image sensor 12, the microphone 42, a camera 44, a force sensor 45, or the tactile sensor 41. The state variable includes at least one of outputs from the image sensor 12, the microphone 42, a camera 44, a force sensor 45, and the tactile sensor 41. The decision making unit 24 decides command data prescribing a movement of the robot 3, based on an output from the value function update unit 23. Thus, command data prescribing a movement of the robot 3 can be decided, based on the output from the value function update unit 23.

Next, machine learning and the machine learning device 2 as a machine learning device will be described.

The machine learning device 2 has the function of extracting, by analysis, a useful rule, knowledge, expression, determination criterion and the like from a data set inputted to the device, outputting the result of the determination, and performing machine learning as learning of knowledge. There are various techniques of machine learning, which are broadly classified into, for example, “supervised learning”, “unsupervised learning”, and “reinforcement learning”. To implement these techniques, a technique called “deep learning” in which a feature value itself is extracted may be employed.

The machine learning device 2 in this embodiment described with reference to FIG. 1 employs “reinforcement learning”. As the machine learning device 2, a general-purpose computer or processor can be used. However, for example, using GPGPU (general-purpose computing on graphics processing units) or large-scale PC cluster or the like enables higher-speed processing.

Machine learning includes various techniques such as “supervised learning” as well as “reinforcement learning”. An outline of these techniques will now be described.

First, “supervised learning” is a model where a large volume of training data, that is, input-outcome data sets, is provided to the machine learning device 2, so as to learn features in these data sets and infer an outcome from an input, that is, inductively acquire an input-outcome relationship.

“Unsupervised learning” is a technique where only a large volume of input data is provided to the machine learning device 2, so as to learn how the input data is distributed and thus allow learning by a device performing compression, classification, shaping and the like of input data, without providing training output data corresponding to the input data. For example, features in these data sets can be grouped into clusters of similar features, or the like. Using this outcome, a certain criterion is provided and output allocation is carried out in such a way as to optimize the criterion. This enables output prediction. There is also a technique called “semi-supervised learning”, as a hybrid problem setting technique between “supervised learning” and “unsupervised learning”. In semi-supervised learning, for example, there is a set of input-output data for some of inputs, whereas there is only input data for the rest of the inputs.

Next, “reinforcement learning” will be described in detail.

First, the problem setting in reinforcement learning takes the following course.
The robot 3 observes the state of the environment and decides its action. The robot 3 is a collaborative robot where the worker 1 and the robot 3 collaboratively work.
The environment changes according to a certain rule and the robot 3's own action may change the environment.
Every time the robot 3 acts, a reward signal comes back.
The total of discount rewards for the future is to be maximized.
Learning starts in the state where a result inducted by an action is totally unknown or imperfectly known. That is, only by actually performing an action, the robot 3 can acquire data of the outcome of the action. In short, the robot 3 needs to search for an optimal action by trial and error.
Learning can be started at a good start point from an initial state where the robot 3 has pre-learned to imitate a movement of the worker 1. Pre-learning is performed, for example, by the “supervised learning” or “inverse reinforcement learning” technique.

Here, “reinforcement learning” is to learn an action as well as to perform evaluation and classification, and thus learn a proper action in consideration of interaction between the environment and the action, that is, a learning method to maximum a reward to be gained in the future. In the description below, Q-learning is employed as an example. However, reinforcement learning is not limited to Q-learning.

Q-learning is a method of learning a value Q(s,a) of selecting an action a in a certain environmental state s. That is, when in a certain state s, an action a that achieves the highest value Q(s,a) can be selected as an optimal action. However, at first, the correct value of the value Q(s,a) for the combination of the state s and the action a is totally unknown. Thus, an agent, that is, an action performer, selects various actions a in a certain state s and is provided with a reward for the action a at the time. Thus, the agent selects a better action, that is, learns the correct value Q(s,a).

Also, to maximize the total of rewards to be gained in the future as a result of actions, the technique is aimed at achieving Q(s,a)=E[Σ(γ^{t})rₜ]. An expected value, which results when the state is changed according to the optimal action, is unknown and therefore is to be learned by searching. An update expression of such a value Q(s,a) can be expressed, for example, by the following expression (1):

Q(sₜ,aₜ)←Q(sₜ,aₜ)+α(rₜ₊₁+γmaxQ(sₜ₊₁,a)−Q(sₜ,aₜ)) (1).

In the expression (1), sₜ represents the state of the environment at time t, and aₜ represents the action at time t. The action aₜ changes the state to sₜ₊₁. rₜ₊₁ represents the reward gained by the change in the state. The term with max is the Q value where the action a that achieves the highest Q value known at the time is selected in the state sₜ₊₁, multiplied by γ. Here, γ is a parameter of 0<γ≤1, called a discount factor. α is a learning coefficient of 0<α≤1.

The expression (1) represents a method of updating the value Q(sₜ, aₜ) of the action aₜ in the state sₜ, based on the reward rₜ₊₁ coming back as a result of the action aₜ. That is, this represents increasing the value Q(sₜ, aₜ) when the value Q(sₜ₊₁,max aₜ₊₁) of an optimal action max a in the next state based on the reward rₜ₊₁ and the action a is higher than the value Q(sₜ, aₜ) of the action aₜ in the state sₜ, and decreasing the Q(sₜ, aₜ) when the value Q(sₜ₊₁, max aₜ₊₁) of the optimal action max a is lower than the value Q(sₜ, aₜ). In short, the value of a certain action in a certain state is approximated to the value of an optimal action in the next state based on a reward immediately coming back as a result and that action.

To express the Q(s, a) on the computer, a method of holding values for all the state-action pairs (s, a) in the form of a table, and a method of preparing a function approximating the Q(s, a) may be employed. In the latter method, the expression (1) can be achieved by adjusting a parameter of an approximation function by stochastic gradient descent or the like. As the approximation function, a neural network, described later, can be used.

Now, a neural network can be used as an approximation algorithm for the value function in “reinforcement learning”.

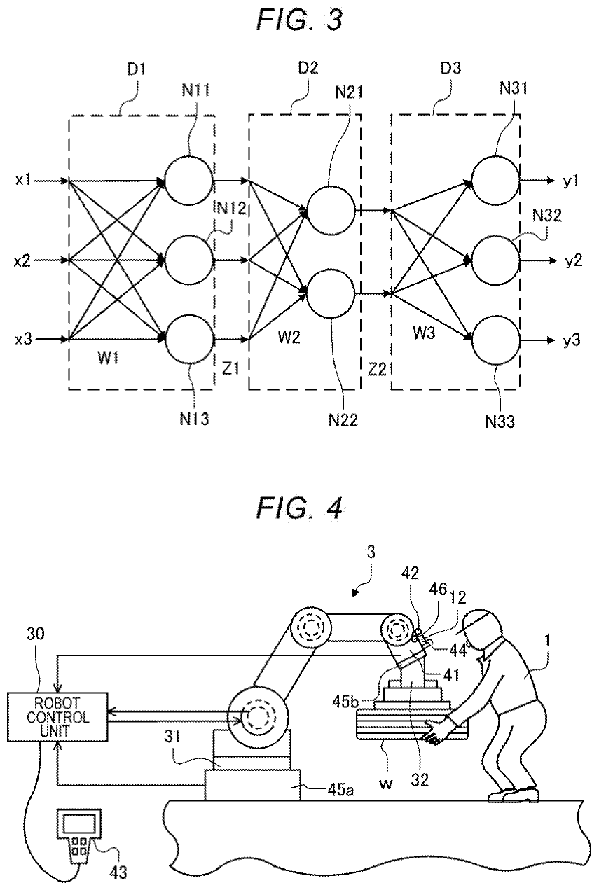

FIG. 2 schematically shows a neuron model. FIG. 3 schematically shows a three-layer neural network formed by a combination of the neurons shown in FIG. 2. That is, the neural network is formed of, for example, an arithmetic device and a memory or the like imitating the neuron model as shown in FIG. 2.

As shown in FIG. 2, the neuron is configured to output an outcome y from a plurality of inputs x (in FIG. 2, inputs x1 to x3 as an example). Each input x (x1, x2, x3) is multiplied by a weight w (w1, w2, w3) corresponding to the input x. Thus, the neuron outputs the outcome y expressed by the expression (2) given below. All of the input x, the outcome y, and the weight w are vectors. In the following expression (2), θ is a bias and fₖ is an activation function.

y=fₖ(Σⁿᵢ₌₁xᵢwᵢ−θ) (2)

The three-layer neural network formed by a combination of the neurons shown in FIG. 2 will now be described with reference to FIG. 3. As shown in FIG. 3, a plurality of inputs x, here inputs x1 to x3 as an example, are inputted from the left side of the neural network, and an outcome y, here outcomes y1 to y3 as an example, are outputted from the right side. Specifically, in a first layer D1 of the neural network, the inputs x1, x2, x3 are inputted with corresponding weights to each of three neurons N11 to N13. The weights applied to these inputs are collectively referred to as W1.

The neurons N11 to N13 output z11 to z13, respectively. In FIG. 3, these z11 to z13 are collectively referred to as a feature vector Z1 and can be regarded as a vector extracting a feature value of the input vector. The feature vector Z1 is a feature vector between the weight W1 and a weight W2. In a second layer D2 of the neural network, z11 to z13 are inputted with corresponding weights to each of two neurons N21 and N22. The weights applied to these feature vectors are collectively referred to as W2.

The neurons N21, N22 output z21, z22, respectively. In FIG. 3, these z21, z22 are collectively referred to as a feature vector Z2. The feature vector Z2 is a feature vector between the weight W2 and a weight W3. In a third layer D3 of the neural network, z21, z22 are inputted with corresponding weights to each of three neuros N31 to N33. The weights applied to these feature vectors are collectively referred to as W3.

Finally, the neurons N31 to N33 output outputs y1 to y3, respectively. The operation of the neural network includes a learning mode and a value prediction mode. For example, in the learning mode, a weight W is learned using a learning data set, and in the prediction mode, an action of the robot is determined using a parameter of the learned weight. Although the term “prediction” is used for the sake of convenience, various tasks such as detection, classification, and inference can be performed.

In the prediction mode, data obtained by actually making the robot move can be immediately learned and then reflected onto the next action as online learning, or bulk learning can be performed as batch learning using a group of data gathered in advance and subsequently a detection mode can be carried out with a parameter of that learning all the time. Alternatively, as an intermediate method, the learning mode can be implemented every time a certain volume of data is accumulated.

The weights w1 to w3 can be learned by backpropagation. Information about an error enters from the right side and flows to the left side. Backpropagation is a technique of learning and adjusting each weight in such a way as to reduce the difference between the outcome y resulting from the input x and the true outcome y of training data. Such a neural network can increase its layers to more than three. This is referred to as deep learning. Also, an arithmetic device performing input feature extraction in stages and returning the outcome can be automatically acquired from training data alone.

As described above, the machine learning device 2 in this embodiment has the state observation unit 21, the reward calculation unit 22, the value function update unit 23, and the decision making unit 24, for example, in order to perform “reinforcement learning or Q-learning”. However, the machine learning method employed in this disclosure is not limited to Q-learning. Any other machine learning method that calculates a reward by adding a second reward based on an action of the worker 1 and a third reward based on a facial expression of the worker 1 can be employed. The machine learning by the machine learning device 2 is achieved, for example, by employing GPGPU, large-scale PC cluster or the like, as described above.

FIG. 4 schematically shows an example of the robot system according to the embodiment and shows an example where the worker 1 and the robot 3 collaboratively transport a workpiece w. In FIG. 4, the reference number 1 represents a worker, 3 represents a robot, 30 represents a robot control unit, 31 represents a base part of the robot 3, and 32 represents a hand part of the robot 3. Also, the reference number 12 represents an image sensor, 41 represents a tactile sensor, 42 represents a microphone, 43 represents an input device, 44 represents a camera, 45a and 45b represent force sensors, 46 represents a speaker, and W represents a workpiece. The machine learning device 2 described with reference to FIG. 1 is provided, for example, at the robot control unit 30. The input device 43 may be, for example, in the shape of a wristwatch and wearable by the worker 1. The input device 43 may be a teach pendant.

The robot system includes the image sensor 12, the camera 44, the force sensors 45a, 45b, the tactile sensor 41, the microphone 42, and the input device 43. The robot system includes the image sensor 12, the camera 44, the force sensors 45a, 45b, the tactile sensor 41, the microphone 42, or the input device 43. The robot system includes at least one of the image sensor 12, the camera 44, the force sensors 45a, 45b, the tactile sensor 41, the microphone 42, and the input device 43.

The image sensor 12 is provided directly at the robot 3 or in a periphery of the robot 3. The camera 44 is provided directly at the robot or in an upper periphery of the robot. The force sensors 45a, 45b are provided at the base part 31 or the hand part 32 of the robot 3 or at a peripheral facility. The tactile sensor 41 is provided at a part of the robot 3 or at a peripheral facility.

In an example of the robot system, the image sensor 12, the microphone 42, the camera 44, and the speaker 46 are provided near the hand part 32 of the robot 3, as shown in FIG. 4. The force sensor 45a is provided at the base part 31 of the robot 3. The force sensor 45b is provided at the hand part 32 of the robot 3. Outputs from the image sensor 12, the microphone 42, the camera 44, the force sensors 45a, 45b, and the tactile sensor 41 are state variables or quantities of state inputted to the state observation unit 21 of the machine learning device 2 described with reference to FIG. 1. The force sensors 45a, 45b detect a force generated by a movement of the robot 3.

The tactile sensor 41 is provided near the hand part 32 of the robot 3. Via the tactile sensor 41, a second reward based on an action of the worker 1 is provided to the reward calculation unit 22 of the machine learning device 2. Specifically, as the second reward, a positive reward is set when the worker 1 strokes the robot 3 via the tactile sensor 41, and a negative reward is set when the worker 1 hits the robot 3. This second reward is added, for example, to a first reward based on the control data and the state variable. The tactile sensor 41 may be provided, for example, in such a way as to cover the entirety of the robot 3. In order to secure safety, the robot 3 can be stopped, for example, when the tactile sensor 41 detects a slight collision.

Alternatively, a positive reward is set when the worker 1 praises the robot 3 via the microphone 42 provided at the hand part 32 of the robot 3, and a negative reward is set when the worker 1 reprimands the robot 3. This second reward is added to the first reward based on the control data and the state variable. However, the second reward given by the worker 1 is not limited to stroking/hitting via the tactile sensor 41 or praising/reprimanding via the microphone 42. The second reward given by the worker 1 via various sensors or the like can be added to the first reward.

The image sensor 12 is provided directly at the robot 3 or in a periphery of the robot 3. The image sensor 12 is provided in a peripheral area of the robot 3, and via this image sensor 12, a third reward based on a facial expression of the worker 1 is provided to the reward calculation unit 22 of the machine learning device 2. Specifically, as the third reward, a facial expression of the worker 1 is recognized in relation to the second reward. A positive reward is set when the facial expression of the worker 1 is a smile or an expression of pleasure, and a negative reward is set when the facial expression of the worker 1 is a frown or a cry. This third reward is added to the first reward based on the control data and the state variable.

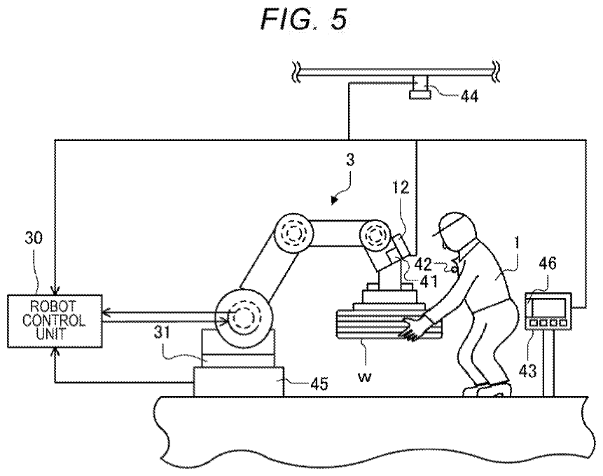

FIG. 5 schematically shows a modification example of the robot system shown in FIG. 4. As is clear from the comparison between FIG. 5 and FIG. 4, in the modification example shown in FIG. 5, the image sensor 12 is provided at a part of the robot 3 where an image of the facial expression of the worker 1 can be easily picked up. The tactile sensor 41 is provided at a part of the robot 3 where the worker 1 can easily makes a stroking/hitting movement. The camera 44 is provided directly at the robot 3 or in an upper periphery of the robot 3. The camera 44 is provided in a peripheral area of the robot 3. The camera 44 has, for example, a zoom function and can pick up an image in an enlarged or reduced form.

The force sensor 45 is provided only at the base part 31 of the robot 3. The microphone 42 is worn by the worker 1. The input device 43 is a fixed device. The speaker 46 is provided at the input device 43. In this way, the image sensor 12, the tactile sensor 41, the microphone 42, the input device 43, the camera 44, the force sensor 45, and the speaker 46 can be provided at various sites. For example, these can be provided at a peripheral facility.

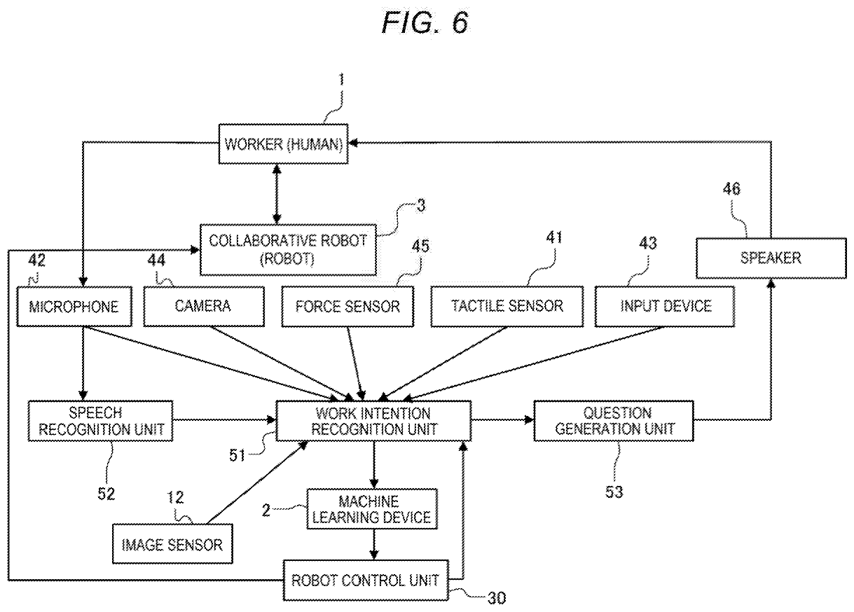

FIG. 6 is a block diagram for explaining an example of the robot system according to this embodiment. As shown in FIG. 6, the robot system includes the robot 3, the robot control unit 30, the machine learning device 2, a work intention recognition unit 51, a speech recognition unit 52, and a question generation unit 53. The robot system also includes the image sensor 12, the tactile sensor 41, the microphone 42, the input device 43, the camera 44, the force sensor 45, and the speaker 46. Here, the machine learning device 2, for example, analyzes the distribution of a feature point or workpiece w after collaborative work by the worker 1 and the robot 3 and thus can learn a movement of the robot 3.

The work intention recognition unit 51 receives for example, an output from the image sensor 12, the camera 44, the force sensor 45, the tactile sensor 41, the microphone 42, and the input device 43, and recognizes the intention of work. The speech recognition unit 52 recognizes a speech by the worker inputted from the microphone 42. The work intention recognition unit 51 corrects the movement of the robot 3, based on the speech recognition unit 52.

The question generation unit 53 generates a question to the worker 1, based on the analysis of the work intention by the work intention recognition unit 51, and delivers the generated question to the worker 1 via the speaker 46. The microphone 42 receives a response from the worker 1 to the question from the speaker 46. The speech recognition unit 52 recognizes the response from the worker 1 inputted via the microphone 42 ad outputs the response to the work intention recognition unit 51.

In the example of the robot system shown in FIG. 6, for example, the state variable inputted to the state observation unit 21 of the machine learning device 2 described with reference to FIG. 1 is provided as an output from the work intention recognition unit 51. Here, the work intention recognition unit 51 converts a second reward based on an action of the worker 1 into a state variable corresponding to the reward and outputs the state variable to the state observation unit 21. Also, the work intention recognition unit 51 converts a third reward based on a facial expression of the worker 1 into a state variable corresponding to the reward and outputs the state carriable to the state observation unit 21. That is, the work intention recognition unit 51 can convert a positive reward based on an action of the worker 1 into a state variable that is set to the positive reward, and output the state variable to the state observation unit 21. Also, the work intention recognition unit 51 can convert a negative reward based on an action of the worker 1 into a state variable that is set to the negative reward, and output the state variable to the state observation unit 21. The work intention recognition unit 51 can convert a positive reward based on a facial expression of the worker 1 into a state variable that is set to the positive reward, and output the state variable to the state observation unit 21. Also, the work intention recognition unit 51 can convert a negative reward based on a facial expression of the worker 1 into a state variable that is set to the negative reward, and output the state variable to the state observation unit 21.

In the robot system, the machine learning device 2 can be set not to learn any more a movement learned up to a predetermined time point. This is, for example, a case where sufficient learning of a movement of the robot has been carried out and where work can be performed more stably by not attempting or learning various other things, or the like. The robot control unit 30 can stop the robot 3 in order to secure safety when the tactile sensor 41 detects a slight collision, as described above. The slight collision is, for example, a collision that is different from stroking/hitting by the worker 1.

An example of processing in the robot system according to this embodiment will now be described, with reference to FIG. 6. For example, a speech made by the worker 1 is inputted to the speech recognition unit 52 via the microphone 42 and its content is analyzed. The content of the speech analyzed or recognized by the speech recognition unit 52 is inputted to the work intention recognition unit 51. Also, a signal from the image sensor 12, the tactile sensor 41, the microphone 42, the input device 43, the camera 44, and the force sensor 45 is inputted to the work intention recognition unit 51. The work intention recognition unit 51 analyzes the intention of the work performed by the worker 1 along with the content of the speech by the worker 1. The signal inputted to the work intention recognition unit 51 is not limited to the above and may be an output from various sensors or the like.

The work intention recognition unit 51 can associate a speech outputted from the microphone 42 with a camera image outputted from the camera 44. For example, when the worker says “Workpiece”, the work intention recognition unit 51 can identify which workpiece it is within the image. This can be achieved, for example, by combining a technology for automatically generating an explanation text for an image by Google (trademark registered) and an existing speech recognition technology.

The work intention recognition unit 51 also has a simple vocabulary. For example, when the worker says “Move the workpiece slightly to the right”, the robot 3 can be made to perform a movement to move the workpiece slightly to the right. This is already achieved, for example, by an operation of a personal computer based on the speech recognition of Windows (trademark registered) or an operation of a mobile device such as a mobile phone based on speech recognition.

In the robot system according to this embodiment, a speech outputted from the microphone 42 and force sensor information of the force sensor 45 can be associated with each other. For example, when the work says “Slightly weaker”, the robot 3 can be controlled in such a way as to weaken the input to the force sensor 45. Specifically, when the worker says “Slightly weaker” in the state where a force in an x-direction is inputted, the robot 3 is controlled in such a way as to weaken the force in the x-direction, for example, to reduce the input of velocity, acceleration, and force in the x-direction.

The work intention recognition unit 51 stores a feature point distribution before and after work within a camera image and can control the robot 3 in such a way that the feature point distribution turns into the state after work. The time points before and after work within the camera image are, for example, when the worker says “Start work” and “End work”. The feature point is, for example, a point that can properly express the work by employing an autoencoder. The feature point can be selected, for example, by the following procedure. The autoencoder is a self-supervised encoder.

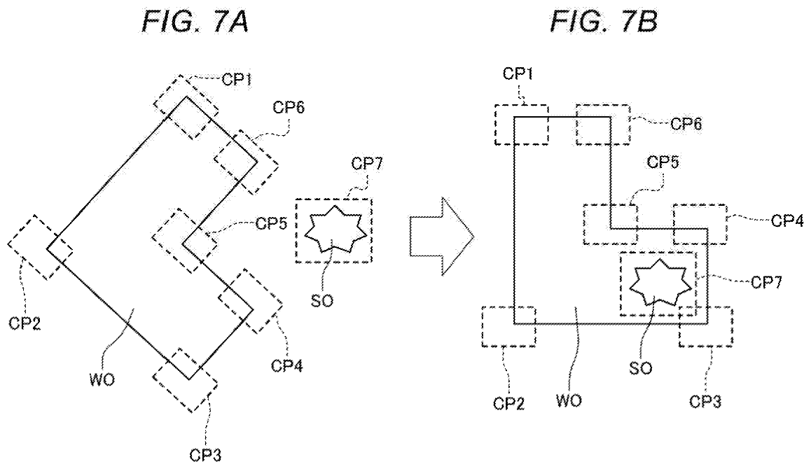

FIGS. 7A and 7B explain an example of a movement in the robot system shown in FIG. 6, and particularly a procedure for selecting a feature point. That is, from the state where an L-shaped workpiece W0 and a star-shaped screw S0 are placed apart from each other as shown in FIG. 7A, a movement of the robot 3 places the star-shaped screw S0 at an end part of the L-shaped workpiece W0 as shown in FIG. 7B.

First, appropriate feature points (CP1 to CP7) are selected and the distributions and positional relationships these before and after work are recorded. The feature points may be set by the worker 1. However, automatic setting of the feature points by the robot 3 is convenient. The automatically set feature points are set at characteristic parts CP1 to CP 6 within the L-shaped workpiece W0 and a part CP7 considered to be star-shaped screw S0, or a point that changes before and after work, or the like. Also, points whose distribution after work has regularity are feature points representing the work well. On the other hand, points whose distribution after work has no regularity are discarded as feature points not representing the work. This processing is performed for every collaborative work. Thus, correct feature points and the distribution of the feature points after work can be employed for machine learning. In some case, slight variation in the distribution of feature points may be allowed. For example, flexible learning can be performed by employing deep learning using a neural network.

For example, in the work of placing the star-shaped screw S0 at an end part of the L-shaped workpiece W0 as shown in FIGS. 7A and 7B, for example, feature points CP1 to CP7 indicated by frames of dashed lines are selected and the distribution of the respective feature points at the end of the work is stored. Then, the objects (W0, S0) are moved in such a way as to achieve the distribution of the feature points at the end of the work, and the work is completed.

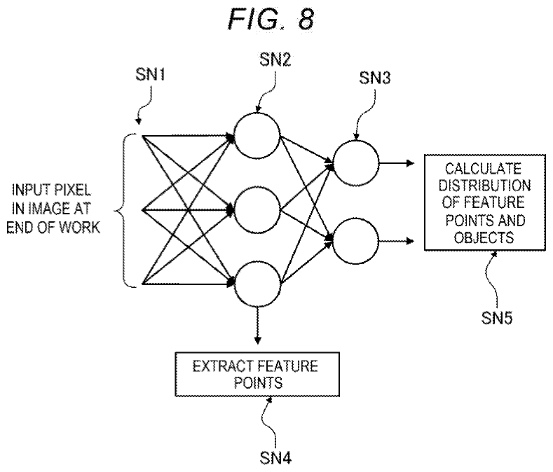

FIG. 8 explains an example of processing in the case where the movement in the robot system shown in FIGS. 7A and 7B is achieved by deep learning employing a neural network. In FIG. 8, first, for example, pixels within an image at the end of the work are inputted to each neuron, as indicated by SN1. The neurons recognize the feature points (CP1 to CP7) and the objects (W0, S0) within the image, as indicated by SN2. Then, the neurons can learn a distribution rule of the feature points and the objects within the image and analyze the work intention, as indicated by SN3. The layers in the neural network is not limited to three layers, that is, an input layer, an intermediate layer, and an output layer. For example, the intermediate layer may be formed of a plurality of layers.

Next, at the time of work, an image before work is transmitted through the neurons, similarly to SN1 to SN3. Thus, feature points are extracted as the recognition of the feature points and the objects within the image, as indicated by SN4. Then, the distribution of the feature points and the objects at the end of the work is calculated by the processing of neurons in SN2 and SN3, as indicated by SN5. The robot 3 is then controlled to move the objects (W0, S0) in such a way as to achieve the calculated distribution of the feature points and the objects, and the work is completed.

Further description will now be given with reference to FIG. 6. For example, when something is unclear or should be confirmed at the time of analysis by the work intention recognition unit 51, this is sent to the question generation unit 53 and the content of a question from the question generation unit 53 is delivered to the worker 1 via the speaker 46, as shown in FIG. 6. Specifically, when the worker 1 says “Move the workpiece further to the right”, for example, the robot 3 or the robot system can move the workpiece slightly to the right and ask the worker 1 a question “Is this position OK?”

The worker 1 responds to the question received via the speaker 46. The content of the response from the worker is analyzed via the microphone 42 and the speech recognition unit 52 and fed back to the work intention recognition unit 51, where the work intention is analyzed again. The result of the analysis by the work intention recognition unit 51 is outputted to the machine learning device 2. The result of the analysis by the work intention recognition unit 51 includes, for example, an output of the state variables converted from and corresponding to the second reward based on the action of the worker 1 and the third reward based on the facial expression of the worker 1. The processing by the machine learning device 2 is described in detail above and therefore will not be described further. An output from the machine learning device 2 is inputted to the robot control unit 30 and utilized to control the robot 3 and, for example, to control the robot 3 in the future, based on the acquired work intention.

The robot tries to improve the work, changing the way of moving and the moving speed little by little even at the time of collaborative work. As described above, as the second reward by the worker 1, a positive/negative reward for the improvement in the work can be set in the form of stroking/hitting via the tactile sensor 41 or praising/reprimanding via the microphone 42. For example, when the worker 1 hits the robot 3 via the tactile sensor 41 and thus sets a negative reward and gives a punishment, the robot 3 can improve the movement, for example, by not making, from then on, a correction in the direction of the change made in the movement immediately before the punishment.

Also, for example, when the robot 3 makes a change to move slightly faster in a certain section and is consequently hit and punished, the robot 3 can improve the movement, for example, by not making a correction to move faster in that section from then on. Also, for example, when the robot 3 has moved only a small number of times or the like and therefore the robot system or the robot 3 does not understand why it is punished, the question generation unit 53 of the robot system can ask the worker 1 a question. Then, for example, when the worker 1 tells the robot 3 to move more slowly, the robot 3 is controlled to move more slowly from the next time.

As described above, as the third reward by the worker 1, the facial expression of the worker 1 is recognized via the image sensor 12, and a positive reward is set when the facial expression of the worker 1 is a smile or an expression of pleasure, whereas a negative reward is set when the facial expression of the worker 1 is a frown or a cry. For example, when the facial expression of the worker 1 via the image sensor 12 is a frown or a cry, the robot 3 can improve the movement, for example, by not making, from then on, a correction in the direction of the change made in the movement immediately before the negative reward is given.

In this way, the robot system or the robot 3 according to this embodiment can not only machine-learn a movement based on a state variable but also correct or improve a movement of the robot 3, based on an action of the worker 1 and a facial expression of the worker 1. Also, the conversation between the work intention recognition unit 51, the speech recognition unit 52, and the question generation unit 53, and the worker 1, enables further improvement in the movement of robot 3. In the conversation between the robot 3 and the worker 1, the question generated by the question generation unit 53 may be not only a question based on collaborative work with the worker 1 such as “Which workpiece should I pick up?” or “Where should I put the workpiece?”, for example, when a plurality of workpieces are found, but also a question originating from the robot itself such as “Is it this workpiece?” or “Is it here?”, for example, when the amount of learning is insufficient and the degree of certainty is low.

According to this embodiment, when giving a reward to the robot 3, a movement of the robot 3 can be corrected or improved, not only by machine learning of a movement based on a state variable but also based on an action of the worker 1 and a facial expression of the worker 1. Thus, the machine learning device 2 can prevent a wrong operation by the worker 1 when giving a reward to the robot 3 in collaborative work with the robot 3.

As described in detail above, in the embodiment of the machine learning device, the robot system, and the machine learning method according to the present disclosure, learning data can be gathered during collaborative work, and a movement of a robot where a human and the robot collaboratively work can be improved further. Also, in the embodiment of the machine learning device, the robot system, and the machine learning method according to the present disclosure, when the human and the robot collaboratively work, the collaborative work can be improved based on information from various sensors and conversion with the human, or the like. In some cases, there is no need for collaboration with the human, and the robot can perform a task on its own.

The embodiment has been described above. However, all the examples and conditions described here are for the purpose of facilitating understanding of the present disclosure and the idea of the present disclosure applied to technology. Particularly, the described examples and conditions are not intended to limit the scope of the present disclosure. Also, such a description in the specification does not represent any advantage or disadvantage of the present disclosure. Although the embodiment of the present disclosure has been described in detail, it should be understood that various changes, replacements, and modifications can be made without departing from the spirit and scope of the present disclosure.

Contents derived from the embodiment are described below.

A machine learning device learning a movement of a robot where a human and the robot collaboratively work includes: a state observation unit observing a state variable representing a state of the robot when the human and the robot collaboratively work; a reward calculation unit calculating a reward based on control data for controlling the robot, the state variable, an action of the human, and a facial expression of the human; and a value function update unit updating an action value function for controlling a movement of the robot, based on the reward and the state variable.

According to this configuration, when giving a reward to the robot, a movement of the robot can be corrected or improved, not only by machine learning of a movement based on a state variable but also based on an action of the human and a facial expression of the human. Thus, the machine learning device can prevent a wrong operation by the human when giving a reward to the robot in collaborative work with the robot.

In the machine learning device, the state variable may include an output from an image sensor, a camera, a force sensor, a microphone, and a tactile sensor.

According to this configuration, an output from the image sensor, the microphone, the camera, the force sensor, and the tactile sensor can be regarded as a state variable or a quantity of state inputted to the state observation unit of the machine learning device.

In the machine learning device, the reward calculation unit may calculate the reward by adding a second reward based on the action of the human and a third reward based on the facial expression of the human to a first reward based on the control data and the state variable.

According to this configuration, the reward can be calculated by adding the second reward based on the action of the human to the first reward based on the control data and the state variable.

In the machine learning device, as the second reward, a positive reward may be set when the robot is stroked via the tactile sensor provided at the robot, and a negative reward may be set when the robot is hit. Alternatively, a positive reward may be set when the robot is praised via a microphone provided at a part of the robot or near the robot or worn by the human, and a negative reward may be set when the robot is reprimanded.

According to this configuration, a positive reward is set when the robot is stroked via the tactile sensor provided at a part of the robot, and a negative reward is set when the robot is hit. The reward can be calculated by adding the second reward based on this action of the human to the first reward based on the control data and the state variable.

In the machine learning device, as the third reward, the facial expression of the human may be recognized via the image sensor provided at the robot, and a positive reward may be set when the facial expression of the human is a smile or an expression of pleasure, and a negative reward may be set when the facial expression of the human is a frown or a cry.

According to this configuration, the facial expression of the human is recognized via the image sensor provided at a part of the robot. A positive reward is set when the facial expression of the human is a smile or an expression of pleasure. A negative reward is set when the facial expression of the human is a frown or a cry. The reward can be calculated by adding the third reward based on this facial expression of the human to the first reward based on the control data and the state variable.

The machine learning device may further include a decision making unit deciding command data prescribing a movement of the robot, based on an output from the value function update unit.

According to this configuration, command data prescribing a movement of the robot can be decided, based on an output from the value function update unit.

In the machine learning device, the image sensor may be provided directly at the robot or in a periphery of the robot. The camera may be provided directly at the robot or in an upper periphery of the robot. The force sensor may be provided at a base part or a hand part of the robot or at a peripheral facility. The tactile sensor may be provided at a part of the robot or at a peripheral facility.

According to this configuration, the image sensor, the tactile sensor, the camera, and the force sensor can be provided at various sites. The various sites may be, for example, peripheral facilities.

A robot system includes the foregoing machine learning device, the robot working collaboratively with the human, and a robot control unit controlling a movement of the robot. The machine learning device learns the movement of the robot by analyzing distribution of a feature point or a workpiece after the human and the robot collaboratively work.

According to this configuration, when giving a reward to the robot, a movement of the robot can be corrected or improved, not only by machine learning of a movement based on a state variable but also based on an action of the human and a facial expression of the human. Thus, the robot system with the human coexistence can prevent a wrong operation by the human when giving a reward to the robot in collaborative work with the robot.

The robot system may further include: an image sensor, a camera, a force sensor, a tactile sensor, a microphone, and input device; and a work intention recognition unit receiving an output from the image sensor, the camera, the force sensor, the tactile sensor, the microphone, and the input device, and recognizing an intention of work.

According to this configuration, a positive reward based on the action of the human can be converted into a state variable that is set to the positive reward and this state variable can be outputted to the state observation unit. Also, a negative reward based on the action of the human can be converted into a state variable that is set to the negative reward and this state variable can be outputted to the state observation unit.

The robot system may further include a speech recognition unit recognizing a speech of the human inputted from the microphone. The work intention recognition unit may correct the movement of the robot, based on the speech recognition unit.

According to this configuration, a positive reward based on the action and facial expression of the human can be converted into a state variable that is set to the positive reward and this state variable can be outputted to the state observation unit. Also, a negative reward based on the action and facial expression of the human can be converted into a state variable that is set to the negative reward and this state variable can be outputted to the state observation unit.

The robot system may further include: a question generation unit generating a question to the human, based on an analysis of work intention by the work intention recognition unit; and a speaker delivering the question generated by the question generation unit to the human.

According to this configuration, a positive reward based on the action and facial expression of the human can be converted into a state variable that is set to the positive reward and this state variable can be outputted to the state observation unit. Also, a negative reward based on the action and facial expression of the human can be converted into a state variable that is set to the negative reward and this state variable can be outputted to the state observation unit.

In the robot system, the microphone may receive a response from the human to the question from the speaker. The speech recognition unit may recognize the response from the human inputted via the microphone and output the response to the work intention recognition unit.

According to this configuration, a positive reward based on the action and facial expression of the human can be converted into a state variable that is set to the positive reward and this state variable can be outputted to the state observation unit. Also, a negative reward based on the action and facial expression of the human can be converted into a state variable that is set to the negative reward and this state variable can be outputted to the state observation unit.

In the robot system, the state variable inputted to the state observation unit of the machine learning device may be an output from the work intention recognition unit. The work intention recognition unit may convert a positive reward based on the action of the human into a state variable that is set to the positive reward, and output the state variable to the state observation unit. The work intention recognition unit may convert a negative reward based on the action of the human into a state variable that is set to the negative reward, and output the state variable to the state observation unit. The work intention recognition unit may convert a positive reward based on the facial expression of the human into a state variable that is set to the positive reward, and output the state variable to the state observation unit. The work intention recognition unit may convert a negative reward based on the facial recognition of the human into a state variable that is set to the negative reward, and output the state variable to the state observation unit.

According to this configuration, a movement of the robot can be corrected or improved, not only by machine learning of a movement based on a state variable but also based on an action of the human and a facial expression of the human. Also, the conversation between the work intention recognition unit and the human can further improve the movement of the robot.

In the robot system, the machine learning device may be able to be set not to learn any more a movement learned up to a predetermined time point.

According to this configuration, for example, sufficient learning of a movement of the robot has been carried out and therefore work can be performed more stably by not attempting or learning various other things, or the like.

In the robot system, the robot control unit may stop the robot when the tactile sensor detects a slight collision.

According to this configuration, in order to secure safety, the robot can be stopped, for example, when the tactile sensor detects a light collision.

A machine learning method for learning a movement of a robot where a human and the robot collaboratively work includes: observing a state variable representing a state of the robot when the human and the robot collaboratively work; calculating a reward based on control data for controlling the robot, the state variable, an action of the human, and a facial expression of the human; and updating an action value function for controlling a movement of the robot, based on the reward and the state variable.

According to this configuration, when giving a reward to the robot, a movement of the robot can be corrected or improved, not only by machine learning of a movement based on a state variable but also based on an action of the human and a facial expression of the human. Thus, in the machine learning method, a wrong operation by the human when giving a reward to the robot in collaborative work with the robot can be prevented.

What is claimed is:

1. A machine learning device learning a movement of a robot where a human and the robot collaboratively work, the device comprising:
a state observation unit observing a state variable representing a state of the robot when the human and the robot collaboratively work;
a reward calculation unit calculating a reward based on control data for controlling the robot, the state variable, an action of the human, and a facial expression of the human; and
a value function update unit updating an action value function for controlling a movement of the robot, based on the reward and the state variable.

2. The machine learning device according to claim 1, wherein
the state variable includes an output from an image sensor, a camera, a force sensor, a microphone, and a tactile sensor.

3. The machine learning device according to claim 1, wherein
the reward calculation unit calculates the reward by adding a second reward based on the action of the human and a third reward based on the facial expression of the human to a first reward based on the control data and the state variable.

4. The machine learning device according to claim 3, wherein
as the second reward,
a positive reward is set when the robot is stroked via the tactile sensor provided at the robot, and a negative reward is set when the robot is hit, or
a positive reward is set when the robot is praised via a microphone provided at a part of the robot or near the robot or worn by the human, and a negative reward is set when the robot is reprimanded.

5. The machine learning device according to claim 3, wherein
as the third reward, the facial expression of the human is recognized via the image sensor provided at the robot, and a positive reward is set when the facial expression of the human is a smile or an expression of pleasure, and a negative reward is set when the facial expression of the human is a frown or a cry.

6. The machine learning device according to claim 1, further comprising
a decision making unit deciding command data prescribing a movement of the robot, based on an output from the value function update unit.

7. The machine learning device according to claim 2, wherein
the image sensor is provided directly at the robot or in a periphery of the robot,
the camera is provided directly at the robot or in an upper periphery of the robot,
the force sensor is provided at a base part or a hand part of the robot or at a peripheral facility, or
the tactile sensor is provided at a part of the robot or at a peripheral facility.

8. A robot system comprising:
the machine learning device according to claim 1;
the robot working collaboratively with the human; and
a robot control unit controlling a movement of the robot, wherein
the machine learning device learns the movement of the robot by analyzing distribution of a feature point or a workpiece after the human and the robot collaboratively work.

9. The robot system according to claim 8, further comprising:
an image sensor, a camera, a force sensor, a tactile sensor, a microphone, and input device; and
a work intention recognition unit receiving an output from the image sensor, the camera, the force sensor, the tactile sensor, the microphone, and the input device, and recognizing an intention of work.

10. The robot system according to claim 9, further comprising
a speech recognition unit recognizing a speech of the human inputted from the microphone, wherein
the work intention recognition unit corrects the movement of the robot, based on the speech recognition unit.

11. The robot system according to claim 10, further comprising:
a question generation unit generating a question to the human, based on an analysis of work intention by the work intention recognition unit; and
a speaker delivering the question generated by the question generation unit to the human.

12. The robot system according to claim 11, wherein
the microphone receives a response from the human to the question from the speaker, and
the speech recognition unit recognizes the response from the human inputted via the microphone and outputs the response to the work intention recognition unit.

13. The robot system according to claim 9, wherein
the state variable inputted to the state observation unit of the machine learning device is an output from the work intention recognition unit, and
the work intention recognition unit
converts a positive reward based on the action of the human into a state variable that is set to the positive reward, and outputs the state variable to the state observation unit,
converts a negative reward based on the action of the human into a state variable that is set to the negative reward, and outputs the state variable to the state observation unit,
converts a positive reward based on the facial expression of the human into a state variable that is set to the positive reward, and outputs the state variable to the state observation unit, and
converts a negative reward based on the facial recognition of the human into a state variable that is set to the negative reward, and outputs the state variable to the state observation unit.

14. The robot system according to claim 8, wherein
the machine learning device is able to be set not to learn any more a movement learned up to a predetermined time point.

15. The robot system according to claim 9, wherein
the robot control unit stops the robot when the tactile sensor detects a slight collision.

16. A machine learning method for learning a movement of a robot where a human and the robot collaboratively work, the method comprising:
observing a state variable representing a state of the robot when the human and the robot collaboratively work;
calculating a reward based on control data for controlling the robot, the state variable, an action of the human, and a facial expression of the human; and
updating an action value function for controlling a movement of the robot, based on the reward and the state variable.
